(19) United States
(12) Patent Application Publication
(10) Pub. No.: US 2008/0253115 A1
(43) Pub. Date: Oct. 16, 2008

(54) Light mixing and light guiding apparatus

(75) Inventor: Jun-Hong Lin, Tainan County (TW)

Correspondence Address: BACON & THOMAS, PLLC, 625 SLATERS LANE, FOURTH FLOOR, ALEXANDRIA, VA, 22314-1176, US

(73) Assignee: CHI LIN TECHNOLOGY CO., LTD., TAINAN COUNTY (TW)

(21) Appl. No.: 11/902,373

(22) Filed: Sep. 21, 2007

(30) Foreign Application Priority Data
Apr. 16, 2007 (TW) 96113375

(51) Int. Cl. F21V 7/09; F21V 13/00; F21V 8/00; F21V 7/00

(52) U.S. Cl. 362/231; 362/277; 362/280; 362/296; 362/311

(57) ABSTRACT

A light mixing and light guiding apparatus includes a main substrate, at least a light emitting device and a curved reflective plate. The main substrate has a reflecting side at a side thereof. The light emitting device is provided on the reflecting side of the main substrate. The curved reflective plate has difference curvatures gradually greater from an end to the other end thereof. An opening is formed between the second lateral edge of the main substrate and the curved reflective plate, and the curved reflective plate substantially covers the main substrate and the light emitting device substantially to achieve the light guiding function. The present invention may mix the light by the repeated reflection between the main substrate and the curved reflective plate.

### BACKGROUND OF THE INVENTION

1. Field of the Invention

The present invention relates generally to a backlight module of a flat display, and more particularly to a light mixing and light guiding apparatus.

2. Description of the Related Art

In conventional light mixing and light guiding techniques of backlight modules, U.S. Pat. No. 5,453,855 discloses a backlight module with two light emitting devices at opposite sides thereof and a reflective plate to reflect light upwards. The character of the patent is the design of the reflective plate. U.S. Pat. No. 5,166,815 provides a backlight module with a light emitting device at a side and a curved reflective plate to reflect light upwards. The character of the patent is the design of the reflective plate also. U.S. Pat. No. 5,833,684 provides a light guide plate with two light emitting devices at opposite sides thereof. The light guide plate has a reflective film surrounding lateral and bottom sides of the light guide plate to guides the light of the light emitting devices only emitting out of the light guide plate via a top side thereof. U.S. application publication no. 2004/0061810 provides a light mixing and guiding plate and a hemispherical reflective lens between a light guide plate and a light emitting device to mix the light of the light emitting device in the light mixing and guiding plate and reflect the light the light reflective lens before enter the light guide plate. The character of the application is the light mixing and guiding plate and the reflective lens.

The first three conventional devices provide the light emitting device at the lateral side and perform the light mixing function in the light guide plate that provides a poor light mixing performance. The fourth conventional device (publication no. 2004/0061810) provides a front end light mixing function. But, this kind of backlight module has a lot of elements, greater size, and greater thickness to take too much space.

### SUMMARY OF THE INVENTION

The primary objective of the present invention is to provide a light mixing and light guiding apparatus, which the light is well mixed before enter the light guide plate.

The secondary objective of the present invention is to provide a light mixing and light guiding apparatus, which the light is well mixed in a short distance.

Another objective of the present invention is to provide a light mixing and light guiding apparatus, which has less volume to take less space.

According to the objectives of the present invention, a light mixing and light guiding apparatus includes a main substrate, at least a light emitting device and a curved reflective plate. The main substrate has a reflecting side at a side thereof. The light emitting device is provided on the reflecting side of the main substrate. The curved reflective plate has difference curvatures and the curvatures are gradually greater from an end to the other end thereof. The main substrate has a first lateral edge associated with the end of the curved reflective plate with a greater curvature and a second lateral edge, which is opposite to the first lateral edge, kept away from the curved reflective plate to form an opening between the second lateral edge of the main substrate and the curved reflective plate, and the curved reflective plate substantially covers the main substrate and the light emitting device substantially. The light emitting device emits light for several reflections between the main substrate and the curved reflective plate, and the reflected light goes to the end of the curved reflective plate with small curvature. At least, the light goes out through the opening to achieve the light guiding function. The present invention may mix the light by the repeated reflection between the main substrate and the curved reflective plate.

### BRIEF DESCRIPTION OF THE DRAWINGS

FIG. 1 is a sectional view of a first preferred embodiment of the present invention;

FIG. 2 is a sectional view of the first preferred embodiment of the present invention in operation;

FIG. 3 is a sectional view of a second preferred embodiment of the present invention; and

FIG. 4 is a sectional view of the second preferred embodiment of the present invention, showing the diffusion plate.

### DETAILED DESCRIPTION OF THE INVENTION

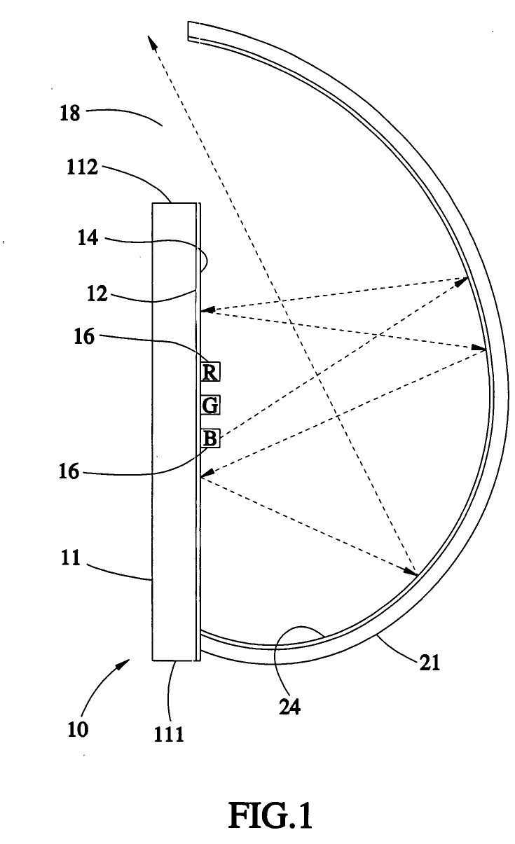

As shown in FIG. 1, a light mixing and light guiding apparatus 10 of the first preferred embodiment of the present invention includes a main substrate, a plurality of light emitting devices 16 and a curved reflective plate 21.

The main substrate 11 has a reflecting side 12, on which a reflective film 14 is attached.

In the present embodiment, the light emitting devices 16 includes a read light LED (light emitting diode) R, a green light LED G and a blue light LED B. The light emitting devices 16 are mounted on the reflecting side 12 of the main substrate 11. In addition, it is easy to understand that the light emitting devices 16 may have LEDs with other colors except for the red light, green light and blue light to achieve the light mixing function.

The curved reflective plate 21 has various curvatures from a great curvature gradually to a small curvature. The main substrate 11 has a first lateral edge 111 at an end of the curved reflective plate 21 with the great curvature and a second lateral edge 112 opposite to the first lateral edge 111 and kept a predetermined distance from the curved reflective plate 21 to form an opening 18 therebetween. The curved reflective plate 21 covers the main substrate 11 and the light emitting devices 16 substantially and is provided with a reflective film 24 on a side facing the main substrate 11.

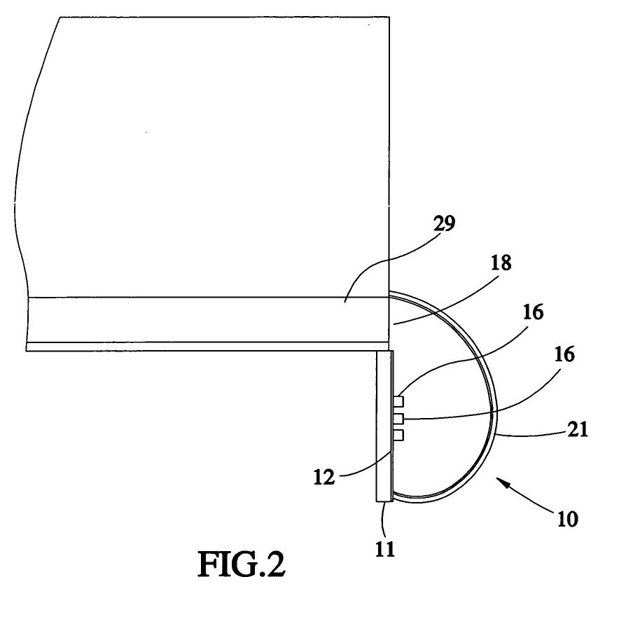

As shown in FIG. 2, in operation of the light mixing and light guiding apparatus 10, it is mounted on a light guide plate 29 with the opening 18 engaged with an end of the light guide plate 29. The light emitting devices 16 emit light reflected between the curved reflective plate 21 and the main substrate 11 and the reflected light goes to an end of the curved reflective plate 21 with the small curvature. At least, the light emits out through the opening 18 and enters the light guide plate 29. As a result, the light is reflected a lots of times between the curved reflective plate 21 and the main substrate 11 to have a well light mixing performance before enter the light guide plate 29.

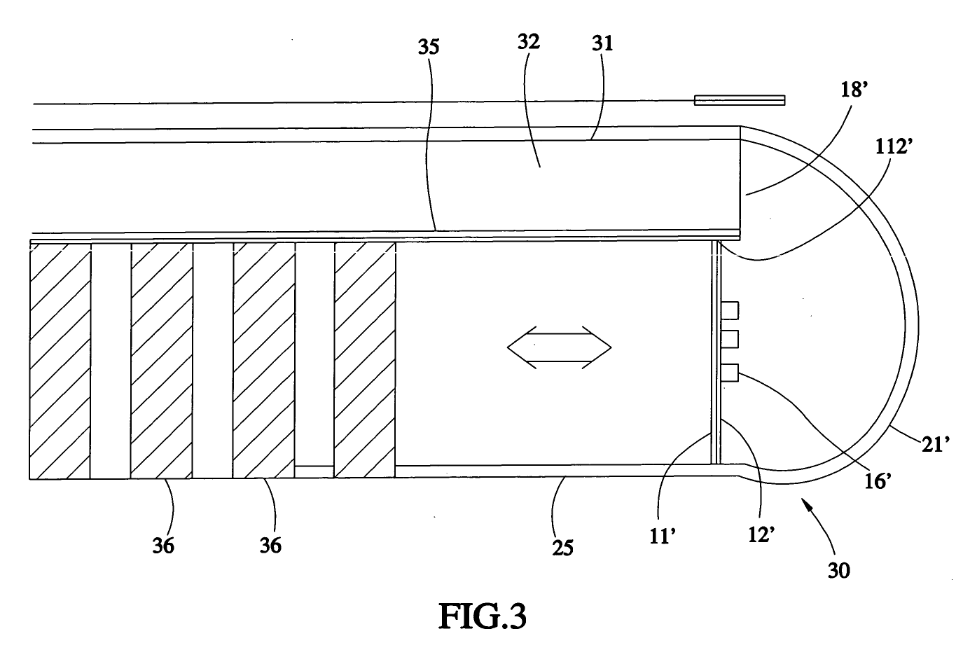

As shown in FIG. 3, a light mixing and light guiding apparatus 30 of the second preferred embodiment of the present invention, which is similar to the first preferred embodiment, includes a main substrate 11′, light emitting devices 16′ and a curved reflective plate 21′. Except that, the light mixing and light guiding apparatus 30 of the second preferred embodiment further includes:

A light guide plate 31 has a light passage 32 aligned with an opening 18′ between the main substrate 11′ and the curved reflective plate 21′. The light guide plate has an edge against an end of the curved reflective plate 21′ with small curvature. A reflective plate 35 is provided on a lateral edge of the light guide plate 31. The main substrate 11′ has a second lateral edge 112′ against an outer edge of the reflective plate 35. The reflective plate 35 has a plurality of fins for heat dissipating.

The curved reflective plate 21′ has an extending wall 25 projected from an end with greater curvature along a normal direction of the main substrate 11′. The main substrate 11′ may move relative to the curved reflective plate 21′. A path of the main substrate 11′ is along a normal direction of a reflecting side 12′ thereof and through the reflective plate 35 and the extending wall 25 to adjust a distance between the main substrate 11′ and the (curved reflective plate 21′ that may change the distance for light mixing.

In the second embodiment, the reflecting side 12′ of the main substrate 11′ and the curved reflective plate 21′ may be smooth metal surfaces for reflection. In addition, it is easy to understand that there are many ways for reflection except for the smooth metal surface and they may be incorporated in the present invention also.

With the structure of the second embodiment, the light emitting devices 16′ emit light for several reflections between the main substrate 11′ and the curved reflective plate 21′, and the reflected light goes to the end of the curved reflective plate 21′ with small curvature. At least, the light enters the light guide plate 31 through the opening 18′. The main substrate 11′ may be adjusted its position to change the distance for light reflection that will change the result of light mixing. Again, the main substrate 11′ is provided with the fins 36 at the outer side thereof that will not take the space therein to achieve heat dissipating function and high efficient usage of space.

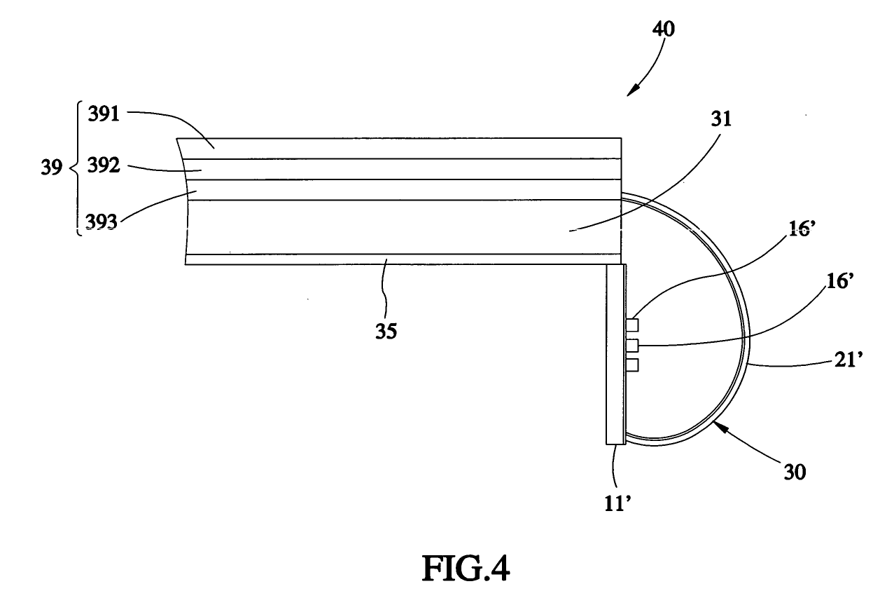

As shown in FIG. 4, the light mixing and light guiding apparatus 30 of the second preferred embodiment may be equipped with a diffusion plate 39 to form a backlight module 40. In other words, the backlight module 40 may have the main substrate 11′, the light emitting devices 16′, the curved reflective plate 21′, and the reflective plate 35 of the light mixing and light guiding apparatus 30 and the diffusion plate 39. The diffusion plate 39 is provided on the light guide plate 31 opposite to the reflective plate 35. The diffusion plate 39 includes an upper diffuser layer 391, a brightness enhancement film (BEF) 392 and a lower diffuser layer 393.

The light of the light emitting devices 16′ is well mixed by the curved reflective plate 21′ and then enters the light guide plate 31, and then is reflected by the reflective plate 35 to enter the diffusion plate 39 for diffusion.

In conclusion, the characters of the present invention are:

1. Well light mixing in a short distance: The main substrate and the curved reflective plate of the present invention reflect light a lot of times and then reflect it to the opening to enter the light guide plate. There is no problem of the light being restrained in the apparatus. The light will have a well light mixing by the repeated reflections.

2. Enhancement of light mixing: The main substrate may be shifted away from the curved reflective plate that will increase the distance of light reflection to enhance the light mixing.

3. Small size and less space taken: There is a shorter distance between the main substrate and the curved reflective plate than prior arts so that the present invention has a smaller size and takes less space to facilitate the designer.

The description above is a few preferred embodiments of the present invention and the equivalence of the present invention is still in the scope of the claim of the present invention.

What is claimed is:

1. A light mixing and light guiding apparatus, comprising:
a main substrate having a reflecting side at a side thereof;
at least a light emitting device provided on the reflecting side of the main substrate; and
a curved reflective plate, which has difference curvatures and the curvatures are gradually greater from an end to the other end thereof, wherein the main substrate has a first lateral edge associated with the end of the curved reflective plate with a greater curvature and a second lateral edge, which is opposite to the first lateral edge, kept away from the curved reflective plate to form an opening between the second lateral edge of the main substrate and the curved reflective plate, and the curved reflective plate substantially covers the main substrate and the light emitting device.

2. The light mixing and light guiding apparatus as defined in claim 1, wherein the light emitting device includes a plurality of light emitting diodes with different colors.

3. The light mixing and light guiding apparatus as defined in claim 1, wherein the main substrate is movable relative to the curved reflective plate.

4. The light mixing and light guiding apparatus as defined in claim 3, wherein the main substrate is moved along a normal direction of the curved reflective plate.

5. The light mixing and light guiding apparatus as defined in claim 1, wherein the curved reflective plate has an extending wall at the end thereof with the greater curvature and along a normal direction of the main substrate.

6. The light mixing and light guiding apparatus as defined in claim 1, wherein the reflecting side of the main substrate and the curved reflective plate are provided with a reflective film respectively for reflection.

7. The light mixing and light guiding apparatus as defined in claim 1, wherein the reflecting side of the main substrate and the curved reflective plate have a smooth metal surface respectively for reflection.

8. The light mixing and light guiding apparatus as defined in claim 1, further comprising a light guide plate having a light passage aligned with the opening between the main substrate and the curved reflective plate.

9. The light mixing and light guiding apparatus as defined in claim 8, wherein the light guide has a lateral edge against the curved reflective plate at the end with a smaller curvature, and main substrate has a second side against a lateral edge of the light guide plate.

10. The light mixing and light guiding apparatus as defined in claim 8, wherein the light guide plate is provided with a reflective plate at a lateral edge and a plurality of fin on an outer side of the reflective plate.

11. A backlight module, comprising:
a main substrate having a reflecting side at a side thereof;
at least a light emitting device provided on the reflecting side of the main substrate;
a curved reflective plate, which has difference curvatures and the curvatures are gradually greater from an end to the other end thereof, wherein the main substrate has a first lateral edge associated with the end of the curved reflective plate with a greater curvature and a second lateral edge, which is opposite to the first lateral edge, kept away from the curved reflective plate to form an opening between the second lateral edge of the main substrate and the curved reflective plate, and the curved reflective plate substantially covers the main substrate and the light emitting device;
a light guide plate having a light passage aligned with the opening between the main substrate and the curved reflective plate and a reflective plate at a side thereof; and
a diffusion plate provided on the light guide plate opposite to the reflective plate.
